(19) United States
(12) Patent Application Publication
(10) Pub. No.: US 2025/0189297 A1
(43) Pub. Date: Jun. 12, 2025

(54) Measuring Device, Machining System and Method for Adjusting a Measuring Device

(71) Applicant: Lessmüller Lasertechnik GmbH, München (DE)

(72) Inventors: Eckhard Lessmüller, München (DE); Christian Truckenbrodt, München (DE)

(21) Appl. No.: 18/688,355

(22) PCT Filed: Aug. 30, 2022
(86) PCT No.: PCT/EP2022/074092

§ 371 Date: Dec. 18, 2024

(30) Foreign Application Priority Data
Aug. 31, 2021 (DE) 102021122438.1

(51) Int. Cl. G01B 9/02015; B23K 26/36; G01B 9/02091

(52) U.S. Cl. CPC G01B 9/02031; B23K 26/36; G01B 9/02091

(57) ABSTRACT

The invention relates to a measuring device (10; 10a) for a machining system (12; 12a) for machining a workpiece (14; 14a) using a high-energy machining beam (16; 16a), wherein the measuring device (10; 10a) comprises a beam generating unit (18; 18a) configured to generate a sample beam (20; 20a) and a reference beam (22; 22a) that can be caused to interfere for the performance of optical interference measurements such as optical coherence tomography; a sample arm (24; 24a) that is optically connected to the beam generating unit (18; 18a) and in which the sample beam (20; 20a) is optically guided so that it can be projected onto the workpiece (14; 14a); a reference arm (26; 26a) that is optically connected to the beam generating unit (18; 18a) and in which the reference beam (22; 22a) is optically guided; and a measuring interface (28; 28a) that can be used to couple the sample beam (20; 20a) into the machining beam (16; 16a); the measuring device (10; 10a) comprising a base module (30; 30a) and an interchangeable module (32; 32a) that is connectable or connected thereto. The interchangeable module (32; 32a) comprises a beam guiding portion (48a) that includes optical components (50a) for guiding the sample beam (20a) and/or the reference beam (22a) and that is configured to form a central portion (52; 52a) of the sample arm (24; 24a) and/or the reference arm (26; 26a).

The invention further relates to a system comprising a measuring device (10; 10a) and a plurality of interchangeable modules (32, 32′, 32″), a machining system (12; 12a) and a method for adjusting a measuring device (10; 10a).

The invention relates to a measuring device for a machining system for machining a workpiece using a high-energy machining beam, an interchangeable module for such a measuring device, a system having at least two different interchangeable modules, a machining system for machining a workpiece using a high-energy machining beam, and a method for adjusting a measuring device.

Measuring devices that can be used to perform optical coherence tomography measurements when machining a workpiece are known from prior art. A common abbreviation for optical coherence tomography is OCT. A sample beam of the measuring device is coupled into a machining beam such as a high-energy laser. The sample beam thus travels in a sample arm. In addition, a reference beam is used, which is obtained by splitting a source beam into a sample beam and a reference beam. The reference beam travels in a reference arm that substantially simulates the sample arm in terms of optical properties, in particular in terms of optical path length.

Depending on the arrangement of the optical components of the machining system relative to the workpiece, the optical path length of the sample arm may vary. If changes are made to the optical path of the machining beam and thus the sample beam, the reference arm must be adapted accordingly. Basically, optical components of the reference arm can be adjusted or changed for this purpose, but this requires work to be carried out directly on the measurement setup. Then there will be a need for regular readjustment or recalibration of the optical components.

Measuring devices whose reference arm is length-adjustable are also known from the prior art. DE 10 2013 008 269 A1, for example, discloses a device in which multiple optical fibers of different lengths are installed, defining channels of different lengths between which it is possible to switch automatically.

Further, a reference arm having a compensation portion that simulates the optical path of the sample beam is known from DE 10 2015 015 112 A1. It is formed by a fiber installed in the measuring device.

A similar piece of fiber that forms part of a reference arm and is built into a measuring device is also known from DE 10 2017 218 494 A1.

Further, the prior art includes reference arms whose length is adjustable automatically. A corresponding device is known, for example, from DE 10 2019 001858 B3. Within the maximum capacity of such an adjustment, the reference arm can be adapted to changes in the length of the sample arm. However, further changes in length also require modifications to the device.

If a measuring device is put into operation in a specific machining system, for example a customer's production line, individual manual adjustments to the optical system are required in all known measuring devices. The optical components used for this purpose are often customized and have to be coordinated differently depending on the individual case. This may involve high costs, requires a high level of expertise when setting up and leaves room for human error arising from the wrong selection of adequate components.

Based on the prior art, there is a need for a reliable and low-cost way to adapt a reference arm of a generic measuring device to a sample arm. In other words, the present invention is based on the task of adapting a sample arm and a reference arm to one another in a reliable and cost-effective manner.

According to the invention, this object is achieved with a measuring device, an interchangeable module, a system, a machining system and a method according to the independent and ancillary claims. Further embodiments can be found in the subclaims.

A measuring device according to the invention may be a measuring device, preferably an OCT measuring device, for a machining system for machining a workpiece using a high-energy machining beam, in particular a machining laser. The measuring device comprises a beam generating unit configured to generate a sample beam and a reference beam that can be caused to interfere, i.e. they can interfere with one another and/or be brought in interference, to perform optical interference measurements such as optical coherence tomography. In other words, this may involve the sample beam and the reference beam interfering with one another in a controlled manner. The measuring device further comprises a sample arm that is optically connected to the beam generating unit and in which the sample beam is optically guided so that it can be and/or is projected onto a measuring object such as the workpiece. The measuring device further comprises a reference arm that is optically connected to the beam generating unit and in which the reference beam is optically guided. In addition, the measuring device comprises a measuring interface, for example a camera interface, that can be and/or is used to couple the sample beam into the machining beam.

The measuring device according to the invention is characterized in particular by the fact that it comprises a base module and an interchangeable module that can be or is connected to it. The base module comprises an initial portion of the reference arm, which is connected to the beam generating unit and comprises optical components for guiding the reference beam; and an end portion of the reference arm, which comprises optical components for guiding the reference beam, including a reflector on which the reference beam is reflected and guided back to the beam generating unit, having passed through the reference arm once.

The interchangeable module further comprises a beam guiding portion that comprises optical components for guiding the reference beam and is configured to form a central portion of the reference arm by optically connecting the initial portion of the reference arm to the end portion of the reference arm when the interchangeable module is connected to the base module.

Alternatively or additionally, the measuring device according to the invention is characterized in particular in that the base module comprises a first portion of the sample arm, which is connected to the beam generating unit and comprises optical components for guiding the sample beam, and a second portion of the sample arm, which comprises optical components for guiding the sample beam. The interchangeable module further comprises a beam guiding portion that comprises optical components for guiding the sample beam and is configured to form a central portion of the sample arm by optically connecting the first portion of the sample arm to the second portion of the sample arm when the interchangeable module is connected to the base module.

Below, in places, the invention is described with reference to an interchangeable module partially forming the reference arm. It is understood that the explanations apply analogously to measuring devices in which an interchangeable module forms part of the sample arm additionally or alternatively.

The invention further relates to an interchangeable module for a measuring device according to the invention.

Furthermore, a method for adjusting a measuring device, preferably for a machining system for machining a workpiece using a high-energy machining beam, in particular a measuring device according to the invention, is proposed. In any case, this measuring device comprises a beam generating unit configured to generate a sample beam and a reference beam that can be caused to interfere for the performance of optical coherence tomography, a sample arm that is optically connected to the beam generating unit and in which the sample beam is optically guided so that it can be projected onto a measuring object such as the workpiece, and a reference arm that is optically connected to the beam generating unit and in which the reference beam is optically guided, the reference arm comprising an initial portion and an end portion that are optically connectable to one another by an interchangeable module, in particular an interchangeable module according to the invention, defining a central portion of the reference arm. Alternatively or additionally, the sample arm comprises a first portion and a second portion that are optically connectable to one another by an interchangeable module, in particular an interchangeable module according to the invention, defining a central portion of the sample arm.

The method comprises adjusting (establishing/setting/adapting) an optical property, in particular an optical path length, of the sample arm. The method further comprises selecting an interchangeable module from a group of interchangeable modules that define central portions having different, in particular invariable, optical properties, preferably having, for example, different optical path lengths and/or different dispersion. The defined path length and/or dispersion may be invariable in each case. The method further comprises adapting an optical property, in particular an optical path length, of the reference arm to the adjusted optical property of the sample arm by connecting the selected interchangeable module to the initial portion and the end portion of the reference arm.

Alternatively or additionally, the method comprises adjusting (establishing/setting/adapting) an optical property of the reference arm. The method further comprises selecting an interchangeable module from a group of interchangeable modules that define central portions having different optical properties. The method further comprises adapting an optical property of the sample arm to the adjusted optical property of the reference arm by connecting the selected interchangeable module to the first portion and the second portion of the sample arm.

The features according to the invention allow a reference arm to be reliably adapted to a sample arm. In other words, the reference arm and sample arm can be adapted to one another reliably and easily. It is possible to compensate for even large optical path differences by selecting an interchangeable module having a correspondingly long or short beam guiding portion. Plus, a high degree of cost efficiency can be achieved. As the reference arm and/or the sample arm are formed with a module, individual adjustments, if any, are only required to a small extent. In addition, identical parts can be used. If measuring devices are set up for different customers, different interchangeable modules can be used to enable customization. Such customization is simple, quick and less error-prone because there is no need for works being carried out inside the measuring device. Thanks to the modular design, a length of a reference arm and/or sample arm can instead be changed from outside without having to manually adjust optical components inside. In addition, a specific measuring device can be used quickly and easily in different machining situations. For example, when using a machining system with widely varying working distances, it is easy and quick to switch between interchangeable modules defining central portions of different lengths for the reference arm and/or the sample arm.

Preferably, the base module further comprises an initial portion of the sample arm, one end of which is connected to the beam generating unit and the other end of which is connected to the measuring interface and comprises optical components for guiding the sample beam. Where an interchangeable module is integrated into the sample arm, the first portion, the central portion and the second portion of the sample arm may collectively form the aforementioned initial portion of the sample arm.

The beam generating unit may be configured to generate short coherence length light, for example white light. The beam generating unit may comprise a beam source and a beam splitter, with the sample arm and reference arm preferably extending from the beam splitter.

The base module and/or interchangeable module may be configured as a self-contained, independent assembly. It is understood that a single interchangeable module or multiple interchangeable modules may be available. In this respect, any replacement of the interchangeable module may also relate to assembly of the measuring device during manufacture. For example, a specific base module may be combined with a specific interchangeable module for a specific customer who may not necessarily see a need to replace the interchangeable module. In such case, the term “interchangeable module” exclusively refers to the manufacturer's perspective. Alternatively, replacing may be provided to take place on the customer's premises and/or by the customer, for example to enable adaptations to changing light paths depending on the machining and/or measuring situation by using a different interchangeable module in each case.

Generally speaking, the invention further relates to a system comprising a measuring device according to the invention and at least two different interchangeable modules according to the invention, which comprise beam guiding portions having different optical path lengths and/or different dispersion. Optical path lengths of different interchangeable modules may differ by at least 5%, at least 10%, at least 25%, at least 50%, at least 100% or even by a multiple, for example by a factor of 2, a factor of 3, a factor of 5 or a factor of 10, in particular compared to a respectively next-longest or next-shortest optical path length. For example, this allows the measuring device to be adapted to changes in the length of the sample arm by selecting an interchangeable module that defines a central portion of suitable length. Alternatively or additionally, dispersion changes in the sample arm due to changed settings or arrangement of sample arm components can be compensated for by selecting an interchangeable module having a suitable dispersion.

The invention further relates to a machining system for machining a workpiece using a high-energy machining beam, in particular using a machining laser, which comprises a measuring device according to the invention and a machining device comprising a machining beam source and machining beam optics by means of which the machining beam can be and/or is projected and/or focused onto the workpiece. The sample beam can be and/or is coupled into the machining beam optics such that it can be and/or is projected and/or focused onto the workpiece through the machining beam optics. The machining beam preferably comprises a machining laser.

The machining device may comprise an industrial robot and/or be partially or completely arranged on an industrial robot. The machining device may comprise a machining head in which the machining beam optics may be arranged, for example. The machining head may be carried by an industrial robot. During machining, a feed of the workpiece relative to the machining beam optics may be provided, which may be generated by moving the workpiece and/or by moving the machining beam optics and the machining head, respectively.

The measuring interface may be a partially transparent mirror, for example. In some embodiments, the measuring interface may be an optical port by means of which the sample beam can be decoupled from the measuring device. It may, for example, be connectable and/or connected to an input port of the machining device, which is formed on the machining head, for example. In some embodiments, in addition to the initial portion, the sample arm comprises another portion adjacent to the initial portion and extending to the workpiece. For example, the sample arm may extend from the beam generating unit to the workpiece. The sample beam may be reflected off the workpiece and thus pass through the sample arm twice.

Preferably, the reference arm reproduces the optical properties of the sample arm at least substantially, at least in terms of optical path length and/or in terms of dispersion. The measuring device may comprise a control unit. The control unit may generally be configured to control functions of the measuring device. For this purpose, it may have at least one computer-readable medium that stores suitable program code, as well as a processing unit such as a processor for executing instructions of the program code. The control unit may in particular be configured to perform software-based dispersion compensation between the sample arm and the reference arm. This may compensate for the fact that the sample arm and reference arm may comprise free beam portions of different lengths, fiber portions of different lengths, different optical fibers and/or different other optical components.

In particular, the optical components of the sample arm comprise at least one optical fiber in which the sample beam is guided. In particular, the optical components of the reference arm comprise at least one optical fiber in which the reference beam is guided. The lengths of the optical fibers of the sample arm and reference arm may be at least substantially coordinated, in particular at least substantially identical. As mentioned, any difference in dispersion caused, for example, by different fiber lengths and/or free beam lengths may also be compensated for with software. The reference arm may thus travel almost completely in a fiber, meaning that it can be easily positioned directly on or atop an industrial robot, for example even moving along with the machining head, or can be easily guided away from the robot by simply moving the fiber.

Preferably, the measuring device comprises a sample scanner. The sample scanner may comprise a pivot mirror or a combination of multiple pivot mirrors. The sample scanner may be a galvanometer scanner. For example, the sample scanner may be configured to specifically deflect the sample beam, directing it onto different positions on the workpiece. The sample beam may be displaceable relative to the machining beam by the sample scanner, in particular parallel and/or transverse to a machining direction.

Preferably, the machining device comprises a machining scanner. The machining scanner may comprise a pivot mirror or a combination of multiple pivot mirrors. The machining scanner may be a galvanometer scanner. For example, the machining scanner may be configured to specifically deflect the machining beam, directing it onto different positions on the workpiece. The sample beam may be couplable into the machining beam such that it can also be deflected by the machining scanner.

According to one embodiment, an optical path length of the beam guiding portion of the interchangeable module is invariable. Where multiple interchangeable modules are used optionally, they may each define a predetermined fixed optical path length. The interchangeable module may be configured without movable and/or adjustable optical components. Since this results in a simple construction, the interchangeable module can be both robust and cost-effective.

A reliable and simple structure as well as easy adaptability of a predetermined optical path length of an interchangeable module can be achieved in particular if the beam guiding portion of the interchangeable module comprises an optical fiber that defines the central portion at least in sections and preferably to a large extent or even completely with the exception of optical connections and/or optical interfaces. The interchangeable module may thus simply comprise an optical fiber of a predetermined length and/or with a certain dispersion, which defines which central portion can be provided by the interchangeable module. In the case of a system having multiple different interchangeable modules, they may each comprise optical fibers of different length and/or with different dispersion properties and/or be identical in construction with the exception of the aforementioned differences.

A simple, stable and reliable attachment to the base module can be achieved in particular if the interchangeable module comprises a housing that is optionally fixable and/or fixed to the base module, and/or if the base module comprises a housing to which the interchangeable module is optionally fixable and/or fixed. In particular, the housing of the interchangeable module is configured to be separate from the housing of the base module. The two modules may be completely enclosed and separable from one another. Preferably, the optical fiber of the interchangeable module is fixed directly or indirectly to the housing of the interchangeable module, for example wrapped around a winding body in a controlled manner, which prevents the optical fiber from moving or deforming.

One embodiment of the invention provides that the initial portion comprises a first optical interface at an end away from the beam generating unit, the end portion comprises a second optical interface at an end away from the reflector, and the beam guiding portion comprises a third optical interface at one end and a fourth optical interface at the other end. Alternatively or additionally, the first portion of the sample arm may comprise a first optical interface at an end away from the beam generating unit, and the second portion of the sample arm may comprise a second optical interface. In addition, the beam guiding portion of the interchangeable module may comprise a third optical interface at one end and a fourth optical interface at the other end. When the interchangeable module is connected to the base module, the first optical interface may be connected to the third optical interface and/or the second optical interface may be connected to the fourth optical interface, in particular simultaneously. This allows the interchangeable module to be attached quickly and reliably. At least one or all of the optical interfaces may be configured as a plug-in connection, screw connection and/or as an optical connector that can be established without tools. The first optical interface and the second optical interface may pass through a wall of the housing of the base module and/or be integrated into it, for example as a socket or plug. Alternatively or additionally, the third optical interface and the fourth optical interface may pass through a wall of the housing of the base module and/or be integrated into it, for example as a socket or plug.

Alternatively or additionally, a mechanical interface my be provided on the base module and/or the interchangeable module to serve as a connector for them. The mechanical interface may, for example, be transferred from a released to a partially or totally fixed state. The partially fixed state may be configured such that the interchangeable module is held in place relative to the base module so that in this state, for example, the optical interfaces may be connected and/or total fixation can be established. The optical interfaces may further be configured and/or arranged such that their connection is automatically established when the mechanical connection of the modules is established.

A high degree of mechanical robustness can be achieved in particular if the initial portion and the end portion of the reference arm or the first portion and the second portion of the sample arm each comprise an optical fiber connected to the first optical interface and to the second optical interface, respectively. Alternatively or additionally, the optical fiber of the interchangeable module may be connected to the third and fourth optical interfaces. In particular, the beam guiding portion is formed by or consists of the optical fiber of the interchangeable module and the optical interfaces connected to it. Connecting the optical interfaces forms a reference arm portion that essentially behaves like a single optical fiber.

Fine adjustment of the optical path length of the reference arm, for example in addition to coarse adjustment by selecting a suitable interchangeable module, can be performed quickly and precisely as needed in particular if the initial portion and/or the end portion of the reference arm comprise a path length adjustment unit by means of which an optical path length of the initial portion and/or the end portion of the reference arm can be changed, in particular automatically. Generally speaking, the reference arm and/or the sample arm may comprise a path length adjustment unit. For example, the path length adjustment unit may comprise the reflector of the end portion, which may be movable for this purpose, in particular in an automated manner. For example, the reference beam is decoupled at an input of the path length adjustment unit, which is formed, for example, by a fiber end of an optical fiber of the end portion, then traveling to the reflector as a free beam. Moving the reflector changes the optical path length of the corresponding free beam portion and thus also the optical path length of the reference arm. Alternatively or additionally, the path length adjustment unit may include a fiber stretcher that specifically lengthens or shortens an optical fiber, in particular a pre-stressed one. Again, software-based dispersion compensation may be used to compensate for dispersion changes that occur during the path length change. An optical path length of the initial portion and/or the end portion of the reference arm may be invariable with the exception of path length changes due to adjustment of the path length adjustment unit. It is understood that this may be realized analogously for the sample arm.

The method according to the invention may provide a step of precisely adapting the optical path length of the reference arm to the optical path length of the sample arm by adjusting the optical path length of the initial portion and/or the end portion of the reference arm using the path length adjustment unit. Generally speaking, precise adaptation may be performed by adjusting the optical path length of the sample arm and/or by adjusting the optical path length of the reference arm, in particular using the path length adjustment unit. The precise adaptation may be automated. For example, the central portions defined by different interchangeable modules and/or different sample arm lengths for different configurations may be stored in the control unit. If a specific configuration of the sample arm is selected, e. g. a specific type of machining, a specific robot, a specific machining head, etc., an adaptation may first be made by selecting a suitable interchangeable module that is connected to the base module. A precise adaptation may then be made, taking into account the optical path length of the central portion defined by the connected interchangeable module as well as the sample arm length of the specific sample arm configuration.

According to the invention, it may be provided that an optical adjustment of the sample arm as well as of the initial portion and the end portion of the reference arm is maintained when the interchangeable module is changed. In other words, the arrangement of the optical components of the base module or the initial portion and the end portion of the reference arm is at least substantially unaffected of whether or not there is an interchangeable module and/or the selection thereof. This allows, for example, the customer to replace an interchangeable module by themselves without having to make time-consuming adjustments to the reference arm.

Below, the present invention is described by way of example with reference to the accompanying figures. The drawing, the specification and the claims contain combinations of numerous features. The skilled person will appropriately consider the features also individually and use them in useful combinations within the scope of the claims. In the drawings:

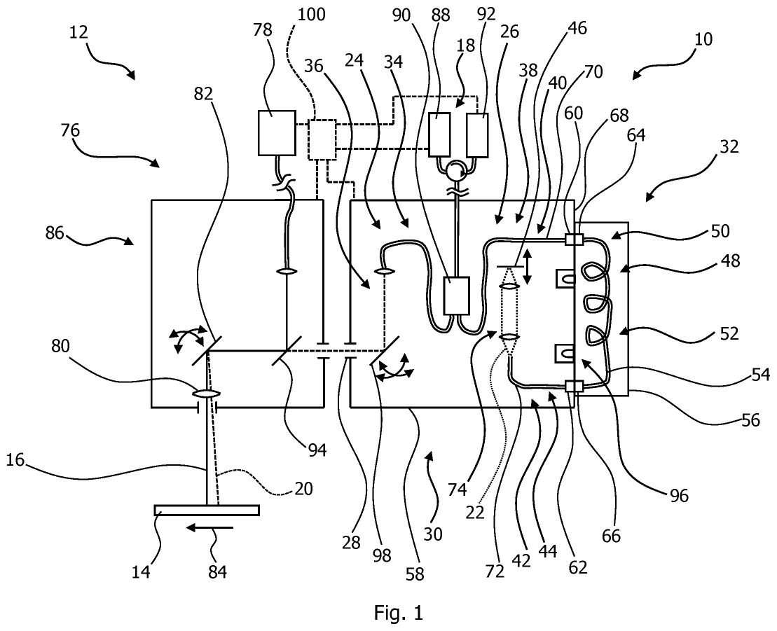

FIG. 1 is a schematic representation of a machining system comprising a measuring device having a base module and an interchangeable module;

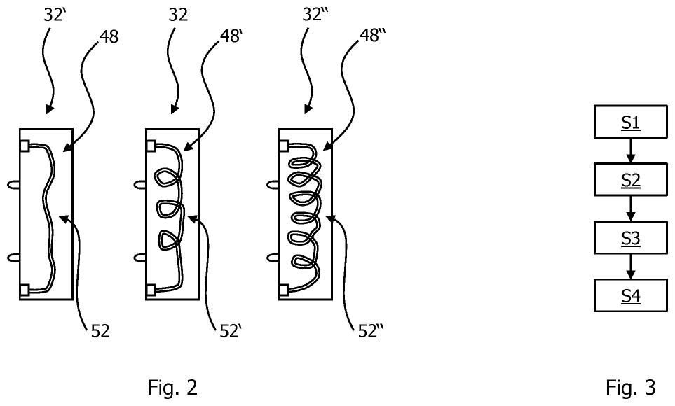

FIG. 2 is a schematic representation of different interchangeable modules;

FIG. 3 is a schematic flow chart of a method for adjusting the measuring device; and

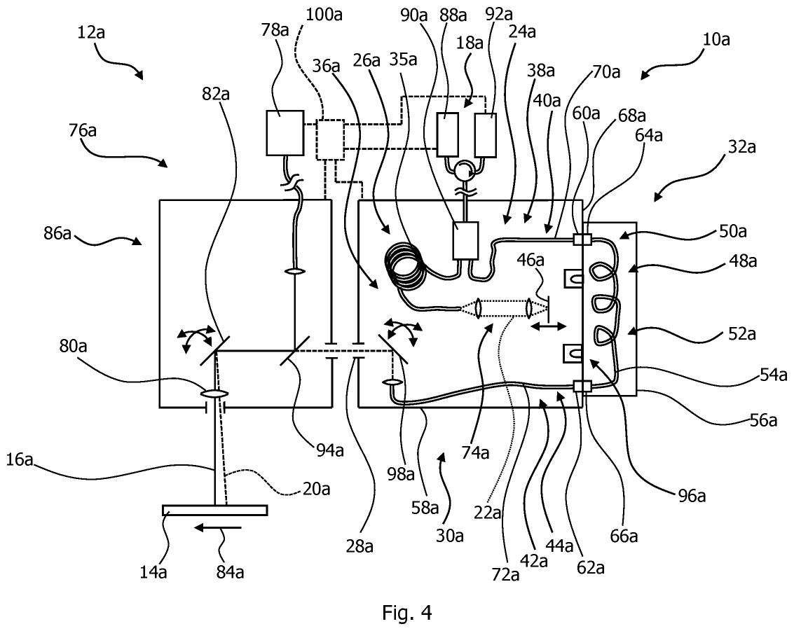

FIG. 4 is a schematic representation of an alternative machining system comprising a measuring device having a base module and an interchangeable module.

FIG. 1 illustrates a machining system 12 comprising a measuring device 10 and a machining device 76. The machining device 76 comprises a machining beam source 78 configured as a machining laser. It generates a machining beam 16 which can be directed onto a workpiece 14 for machining of the latter. This can be, for example, a machining laser beam.

The machining device 76 comprises a machining scanner 82 that makes the machining beam 16 displaceable. The machining scanner 82 comprises, for example, a mirror arrangement that makes the machining beam 16 automatically displaceable in two spatial directions, e. g. parallel and transverse to a machining direction 84. The machining beam 16 is focused onto the workpiece via a schematically illustrated machining beam optics 80 of the machining device 76.

In the present case, the machining device 76 includes a machining head 86 that may be attached to an industrial robot, for example, which is not shown.

The machining system 12 further comprises a measuring device 10. The measuring device 10 comprises a beam generating unit 18 having, for example, a sample beam source 88 and a beam splitter 90 coupled to it. A sample arm 24 and a reference arm 26 extend from the beam splitter 90. A sample beam 20 is optically guided in the sample arm 24. A reference beam 22 is optically guided in the reference arm 26.

The sample arm 24 and the reference arm 26 are connected to a sample unit 92, within which the sample beam 20 and the reference beam 22 interfere with each other. In the case shown, the sample unit 92 comprises a spectrometer enabling optical coherence measurements on the basis of the interference of the sample beam 20 and the reference beam 22. These measurements allow optical coherence tomography to be carried out, for example to determine a height or depth profile of a portion of the workpiece 14 to be machined and/or already machined and/or currently being machined. It is also possible, for example, to determine a penetration depth of the machining beam 16 into the workpiece 14, in particular into a vapor cavity that is formed.

The sample arm 24 extends from the beam generating unit 18 to the workpiece 14. The reference arm extends from the beam generating unit 18 to its end at which a reflector 46 is arranged. In the case shown, the reflector 46 is a mirror belonging to a path length adjustment unit 74 that makes an optical path length of the reference arm 26 adjustable. This allows the optical path length of the reference arm 26 to be adjusted to the optical path length of the sample arm 24.

The sample beam 24 is couplable into the machining beam 16 via a measuring interface 28. In the case shown, the measuring interface 28 is an optical port via which the sample beam 20 is guided to a partially transparent mirror 94. In other embodiments, the measuring device 10 and the machining device 76 may be integrally formed. In such a case, for example, the partially transparent mirror 94 or another optical element for coupling forms the measuring interface 28.

The measuring device 10 further comprises a sample scanner 98. The sample scanner 98 comprises, for example, a mirror arrangement that makes the sample beam 20 automatically displaceable in two spatial directions, e. g. parallel and transverse to the machining direction 84. In the present machining system 12, the sample beam 20 is deflectable relative to the machining beam 16 so that a machining point and sample point can be set independently of one another. As can be seen in FIG. 1, the sample scanner 98 only deflects the sample beam 20 whereas the machining scanner 82 deflects both the machining beam 16 and the sample beam 20. This enables the aforementioned independent displacement of the machining beam 16 and the sample beam 20.

The measuring device 10 has a modular design. It comprises a base module 30 and an interchangeable module 32. In the base module 30, an initial portion 34 of the sample arm 24 is provided, which comprises optical components 36 for guiding the sample beam 20. The initial portion 34 of the sample arm 24 is followed by a portion in which the sample beam 20 is guided to the workpiece 14. In addition, an initial portion 38 and an end portion 42 of the reference arm 26 are provided in the base module 30, each comprising corresponding optical components 40, 44 for guiding the reference beam 22. In the example shown, the end portion 42 of the reference arm 26 comprises the path length adjustment unit 74, which, alternatively or additionally, may be provided in the initial portion 38 of the reference arm 26. The base module 30 has its own housing 58 and may form a self-contained assembly.

An interchangeable module 32 is connected to the base module 30. The interchangeable module 32 comprises a beam guiding portion 48 with optical components 50 for guiding the reference beam 22, which may form a central portion 52 of the reference arm 26 when the interchangeable module 32 is connected. The reference arm 26 is thus formed by its initial portion 38, its central portion 52 and its end portion 42, with the central portion 52 extending in another module. The interchangeable module 32 has its own housing 56 and may be configured as a self-contained assembly.

The beam guiding portion 48 of the interchangeable module 32 has an invariable optical path length. In the case shown, the interchangeable module 32 comprises an optical fiber 54 of predetermined length.

The optical fiber 54 is connected to optical interfaces 64, 66 of the interchangeable module 32, via which the interchangeable module 32 is connectable to the base module 30.

For this purpose, the base module 30 has optical interfaces 60, 62 which are configured to correspond to those of the interchangeable module 32. For example, this may be a combination of a plug and socket. An optical fiber 70, 72, assigned to the initial portion 38 and the end portion 42 of the reference arm 26, respectively, is connected to each of the optical interfaces 60, 62 of the base module 30.

The optical interfaces 60, 62, 64, 66 are integrated into the housings 56, 58 of the base module 30 and the interchangeable module 32, respectively. In the case shown, for example, the housing 58 of the base module 30 has a wall 68 into which the optical interfaces 60, 62 are built or through which they extend to the outside. In the present example, the same applies to the optical interfaces 64, 66 of the interchangeable module 32.

The optical interfaces 60, 62, 64, 66 make it possible to integrate the beam guiding portion 48 of the interchangeable module 32 into the reference arm 26 easily and quickly while not requiring any significant conversion so that the central portion 52 is formed by the interchangeable module 32. The length of the reference arm 26 can thus be easily adjusted by selecting a specific length of the beam guiding portion 48 or the optical fiber 54 connected to the optical interfaces 64, 66 of the interchangeable module 32.

The optical interfaces 60, 62 or the wall 68 of the base module 30 are accessible from the outside, i.e. there is no need to open the base module 30 or access the initial portion 38 or the end portion 42 of the reference arm 26 to replace and/or connect the interchangeable module 32.

The interchangeable module 32 and the base module 30 may further have mechanical elements that form a mechanical interface 96. In FIG. 1, for example, bolts and corresponding receptacles are provided on the interchangeable module 32 and in the base module 30, respectively. According to the invention, however, the mechanical interface 96 may be established with any other means. For this purpose, a simple combination of screws and internal threads is just as suitable as a combination of threaded bolts and nuts, latching locks, magnetic locks, eccentric locking cam arrangements of the type of a quick-release fastener, a combination of suitable rails, elements for hooking in the interchangeable module 32, etc.

With the mechanical interface 96, the housings 56, 58 of the modules 30, 32 can be detachably fixed to one another.

With reference to FIG. 2, it can be seen that instead of the interchangeable module 32, other interchangeable modules 32′, 32″ comprising beam guiding portions 48, 48′, 48″ that define the central portions 52, 52′, 52″ with different optical properties can be used. In the case shown, the three interchangeable modules 32, 32′, 32″ define three different optical path lengths as examples. Alternatively or additionally, interchangeable modules differing in terms of dispersion may be used. Depending on which interchangeable module 32, 32′, 32″ is connected to the base module 30, this results in different reference arm length. This allows the machining system 12 to be adapted, taking into account, for example, widely varying distances between the machining beam optics 80 or the machining head 86 and the workpiece 14. Also, dispersion adaptation may be performed by using interchangeable modules 32, 32′, 32″ with different dispersion for the same or similar optical path length, for example, if, depending on the machining scenario, the machining beam 20 travels through different media and the optical properties of the sample arm change as a result.

When replacing the interchangeable module 32, the optical configuration in the base module 30 remains evidently unchanged. There is no need for complex manual adjustments, conversions or adaptations; rather, the central portion 52 of the reference arm 26 can be replaced easily. The different interchangeable modules 32, 32′, 32′″ are identical parts, i.e. any customer-specific adaptation includes the selection of a suitable interchangeable module 32, 32′, 32″, however, it is not absolutely necessary, for example, to individually cut optical fibers to length for the construction of the reference arm for a specific customer or to make customer-specific adaptations to dispersion.

Again with reference to FIG. 1, the measuring device 10 comprises a control unit 100 configured to control its components. The control unit 100 is shown as a common control unit of the machining system 12. It is understood that, for example, the base module 30 and the machining device 76 may additionally or alternatively have individual control units.

The control unit 100 is configured to evaluate measurement data/raw data determined by the measuring unit 92 and/or to transfer them via a data interface. In the present case, the control unit 100 is further configured to perform a software-based dispersion compensation between the sample arm 24 and reference arm 26, which contributes to increasing the quality of the data obtained and thus the accuracy of, for example, a height profile obtained, a measured penetration depth of the machining beam 16 into the material of the workpiece 14, etc. The control unit 100 may further be configured to control the path length adjustment unit 74 to automatically adapt the optical path length of the reference arm 26. This may be done with a suitable actuator by means of which the reflector 46 is movable. As mentioned, however, other variants of path length adjustment are conceivable within the scope of the invention.

FIG. 3 is a schematic flow chart of a method for adjusting the measuring device 10. In a step S1, an optical property, such as the optical path length, of the sample arm is adjusted. This may include establishing a specific machining configuration, adjusting a specific relative position of the workpiece 14 and the machining head 86, replacing specific optical components of the machining device 76, changing the machining beam source 78 used, and the like.

In a step S2, a specific interchangeable module is selected from a group of interchangeable modules, for example one of the three interchangeable modules 32, 32′, 32″ shown in FIG. 2.

In a step S3, the optical path length of the reference arm 26 is adapted by connecting the selected interchangeable module to the initial portion 38 and the end portion 42 of the reference arm 26. In the process, the optical properties of the central portion 52 of the reference arm 26 are defined. For example, the optical path length of the central portion 52, and thus the optical path length of the reference arm 26, is defined by selecting an interchangeable module 32 whose beam guiding portion 48 has a specific fixed optical path length. The adaptation may be a rough adaptation.

Optionally, the method comprises a step S4 in which an optical path length of the reference arm 26 is adjusted precisely. For this purpose, the optical path length of the initial portion 38 or the end portion 42 of the reference arm 26 is adjusted with the path length adjustment unit 74. If interchangeable modules 32, 32′, 32″ are provided whose optical path lengths gradually differ by no more than the maximum path length change that the path length adjustment unit 74 can provide, the interchangeable modules 32, 32′, 32″ and path length adjustment unit 74 may be combined for a continuously variable optical path length adjustment.

FIG. 4 is a schematic representation of an alternative machining system 12a comprising a measuring device 10a having a base module 30a and an interchangeable module 32a. The alternative machining system 12a is basically configured in analogy to the machining system 12 described above. For differentiation purposes, the reference signs in FIG. 4 are followed by “a”. With regard to the description of the corresponding components, reference is generally made to the above description.

The alternative machining system 12a differs from the machining system 12 in that the interchangeable module 32a forms part of the sample arm 24a. In further embodiments, both the sample arm and the reference arm may each be partially formed by an interchangeable module.

In the alternative machining system 12a, the sample arm 24a comprises a first portion 38a and a second portion 42a. They each comprise optical components 40a, 44a for guiding the sample beam 20a. The interchangeable module 32a comprises a beam guiding portion 48a that includes optical components 50a for guiding the sample beam 20a and that is configured to form a central portion 52a of the sample arm 24a. In analogy to the case described above, interchangeable modules having beam guiding portions of different lengths may be used to adapt the length of the sample arm 24a.

In this embodiment, the reference arm 26a comprises a reference arm fiber 35a. It may have a length that corresponds to the greatest possible length of the sample arm 24a. If the sample beam 20a is guided to the workpiece 14a over a large distance, an interchangeable module 32a having a short beam guiding portion 48a may be used. If the distance to the workpiece 14a is shorter, an interchangeable module 32a having a longer beam guiding portion 48a may be used. The length of the sample arm 24a can thus be adapted to the length of the reference arm 26a.

Regardless of whether an interchangeable module 32, 32a is integrated into the sample arm 24, 24a and/or into the reference arm 26, 26a, the selection of a suitable interchangeable module 32, 32a generally serves to equalize the optical path lengths of the sample arm 24, 24a and the reference arm 26, 26a.

In the case shown, the reference arm 26a comprises a path length adjustment unit 74a 5 configured as described above. In further embodiments, a path length adjustment unit 74a may alternatively or additionally be part of the sample arm 24a.

The method described above may be performed analogously with the alternative machining device 12a, with optical properties of the reference arm 26 being adjusted, and the length of 10 the sample arm 24a being adapted accordingly by selecting a suitable interchangeable module 32a.

1. A measuring device (10; 10a) for a machining system (12; 12a) for machining a workpiece (14; 14a) using a high-energy machining beam (16; 16a), the measuring device (10; 10a) comprising:
a beam generating unit (18; 18a) configured to generate a sample beam (20; 20a) and a reference beam (22; 22a) that can be caused to interfere for the performance of optical interference measurements such as optical coherence tomography;
a sample arm (24; 24a) that is optically connected to the beam generating unit (18; 18a) and in which the sample beam (20; 20a) is optically guided so that it can be projected onto the workpiece (14; 14a);
a reference arm (26; 26a) that is optically connected to the beam generating unit (18; 18a) and in which the reference beam (22; 22a) is optically guided; as well as
a measuring interface (28; 28a) that can be used to couple the sample beam (20; 20a) into the machining beam (16; 16a);
the measuring device (10; 10a) comprising a base module (30; 30a) and an interchangeable module (32; 32a) that is connectable or connected thereto;
a) the base module (30) comprising:
an initial portion (38) of the reference arm (26), which is connected to the beam generating unit (18) and comprises optical components (40) for guiding the reference beam (22); as well as
an end portion (42) of the reference arm (26), which comprises optical components (44) for guiding the reference beam (22), including a reflector (46) on which the reference beam (22) is reflected and guided back to the beam generating unit (18), having passed through the reference arm (26) once; and
the interchangeable module (32) comprising:
a beam guiding portion (48) that comprises optical components (50) for guiding the reference beam (22) and is configured to form a central portion (52) of the reference arm (26) by optically connecting the initial portion (38) of the reference arm (26) to the end portion (42) of the reference arm (26) when the interchangeable module (32) is connected to the base module (30); and/or
b) the base module (30a) comprising:
a first portion (38a) of the sample arm (24a), which is connected to the beam generating unit (18a) and comprises optical components (40a) for guiding the sample beam (20a); as well as
a second portion (42a) of the sample arm (24a), which comprises optical components (44a) for guiding the sample beam (20a); and
the interchangeable module (32a) comprising:
a beam guiding portion (48a) that comprises optical components (50a) for guiding the sample beam (20a) and is configured to form a central portion (52a) of the sample arm (24a) by optically connecting the first portion (38a) of the sample arm (24a) to the second portion (42a) of the sample arm (24a) when the interchangeable module (32a) is connected to the base module (30a).

2. The measuring device (10; 10a) of claim 1, wherein an optical path length of the beam guiding portion (48; 48a) of the interchangeable module (32; 32a) is invariable.

3. The measuring device (10; 10a) of claim 1 or 2,
wherein the beam guiding portion (48; 48a) of the interchangeable module (32; 32a) comprises an optical fiber (54; 54a) defining the central portion (52; 52a) at least in sections.

4. The measuring device (10; 10a) of any one of the preceding claims, wherein the interchangeable module (32; 32a) comprises a housing (56; 56a) optionally fixable to the base module (30; 30a).

5. The measuring device (10; 10a) of any one of the preceding claims,
wherein the base module (30; 30a) comprises a housing (58; 58a) to which the interchangeable module (32; 32a) is optionally fixable.

6. The measuring device (10; 10a) of any one of the preceding claims,
a) wherein the initial portion (38) of the reference arm (26) comprises a first optical interface (60) at an end away from the beam generating unit (18), the end portion (42) of the reference arm (26) comprises a second optical interface (62) at an end away from the reflector (46), and the beam guiding portion (48) of the interchangeable module (32) comprises a third optical interface (64) at one end and a fourth optical interface (66) at the other end; and
wherein, when the interchangeable module (32) is connected to the base module (30), the first optical interface (60) is connected to the third optical interface (64) while the second optical interface (62) is connected to the fourth optical interface (66); and/or
b) wherein the first portion (38a) of the sample arm (24a) comprises a first optical interface (60a) at an end away from the beam generating unit (18a), the second portion (42a) of the sample arm (24a) comprises a second optical interface (62a), and the beam guiding portion (48a) of the interchangeable module (32a) comprises a third optical interface (64a) at one end and a fourth optical interface (66a) at the other end; and
wherein, when the interchangeable module (32a) is connected to the base module (30a), the first optical interface (60a) is connected to the third optical interface (64a) while the second optical interface (62a) is connected to the fourth optical interface (66a).

7. The measuring device (10; 10a) of claims 5 and 6,
wherein the first optical interface (60; 60a) and the second optical interface (62; 62a) pass through and/or are integrated into a wall (68; 68a) of the housing (58; 58a) of the base module (30; 30a).

8. The measuring device (10; 10a) of claim 6 or 7,
a) wherein the initial portion (38) and the end portion (42) of the reference arm (26) each comprise an optical fiber (70, 72) connected to the first optical interface (60) and to the second optical interface (62), respectively; and/or
b) wherein the first portion (38a) and the second portion (42a) of the sample arm (24a) each comprise an optical fiber (70a, 72a) connected to the first optical interface (60a) and to the second optical interface (62a), respectively.

9. The measuring device (10; 10a) of any one of the preceding claims,
a) wherein the reference arm (26; 26a) and/or the sample arm (24; 24a) comprise a path length adjustment unit (74; 74a) that is used to change, in particular automatically, an optical path length of the reference arm (26; 26a) and/or the sample arm (24; 24a).

10. The measuring device (10; 10a) of any one of the preceding claims,
a) wherein an optical adjustment of the sample arm (24) as well as of the initial portion (38) and the end portion (42) of the reference arm (26) is maintained when the interchangeable module (32) is changed; and/or
b) wherein an optical adjustment of the reference arm (26a) as well as of the first portion (38a) and the second portion (42a) of the sample arm (24a) is maintained when the interchangeable module (32a) is changed.

11. An interchangeable module (32; 32a) for a measuring device (10; 10a) of any one of the preceding claims.

12. A system comprising a measuring device (10; 10a) of any one of claims 1 to 10 and at least two different interchangeable modules (32, 32′, 32″), each of claim 11, comprising beam guiding portions (48, 48′, 48″) having different optical path lengths and/or different dispersion.

13. A machining system (12; 12a) for machining a workpiece (14; 14a) using a high-energy machining beam (16; 16a), comprising:
a measuring device (10; 10a) of any one of claims 1 to 10; and
a machining device (76; 76a) comprising a machining beam source (78; 78a) and machining beam optics (80; 80a) that are used to project and/or focus the machining beam (16; 16a) onto the workpiece (14; 14a);
wherein the sample beam (20; 20a) can be coupled into the machining beam optics (80; 80a) such that it can be projected and/or focused onto the workpiece (14; 14a) through the machining beam optics (80; 80a)

14. A method for adjusting a measuring device (10; 10a) for a machining system (12; 12a) for machining a workpiece (14; 14a) using a high-energy machining beam (16; 16a), in particular a measuring device (10; 10a) of any one of claims 1 to 10 comprising a beam generating unit (18; 18a) configured to generate a sample beam (20; 20a) and a reference beam (22; 22a) that can be caused to interfere for the performance of optical coherence tomography, a sample arm (24; 24a) that is optically connected to the beam generating unit (18; 18a) and in which the sample beam (20; 20a) is optically guided so that it can be projected onto the workpiece (14; 14a), and a reference arm (26; 26a) that is optically connected to the beam generating unit (18; 18a) and in which the reference beam (26; 26a) is optically guided,
a) the reference arm (26) having an initial portion (38) and an end portion (42) that are optically connectable to one another by an interchangeable module (32), in particular an interchangeable module (32) of claim 11, defining a central portion (52) of the reference arm (26),
the method comprising:
Adjusting an optical property of the sample arm (24);
Selecting an interchangeable module (32, 32′, 32″) from a group of interchangeable modules (32, 32′, 32″) defining central portions (52, 52′, 52′) having different optical properties; and
Adapting an optical property of the reference arm (26) to the adjusted optical property of the sample arm (24) by connecting the selected interchangeable module (32, 32′, 32″) to the initial portion (38) and the end portion (42) of the reference arm (26), and/or
b) the sample arm (24a) having a first portion (38a) and a second portion (42a) that are optically connectable to one another by an interchangeable module (32a), in particular an interchangeable module (32a) of claim 11, defining a central portion (52a) of the sample arm (24a),
the method comprising:
Adjusting an optical property of the reference arm (26a);
Selecting an interchangeable module (32, 32′, 32″) from a group of interchangeable modules (32, 32′, 32′') defining central portions (52, 52′, 52′) having different optical properties; and
Adapting an optical property of the sample arm (24a) to the adjusted optical property of the reference arm (26a) by connecting the selected interchangeable module (32, 32′, 32″) to the first portion (38a) and the second portion (42a) of the sample arm (24a).

15. The method of claim 14, wherein the reference arm (26; 26a) and/or the sample arm (24; 24a) comprise a path length adjustment unit (74; 74a) that is used to change, in particular automatically, an optical path length of the reference arm (26; 26a) and/or the sample arm (24; 24a),
the method further comprising:
Precisely adapting an optical path length of the reference arm (26; 26a) to an optical path length of the sample arm (24; 24a) by adjusting the optical path length of the reference arm (26; 26a) and/or the sample arm (24; 24a) using the path length adjustment unit (74).
